(19) United States
(12) Patent Application Publication
(10) Pub. No.: US 2025/0113010 A1
(43) Pub. Date: Apr. 3, 2025

(54) Video Group Calling

(71) Applicant: Apple Inc., Cupertino, CA (US)

(72) Inventors: Vidur GUPTA, San Jose, CA (US); Abishek Kumar VAIDYANATHAN, Union City, CA (US); Gaurav LAMBA, Los Altos, CA (US); Li LI, Saratoga, CA (US)

(21) Appl. No.: 18/899,223

(22) Filed: Sep. 27, 2024

Related U.S. Application Data
(60) Provisional application No. 63/586,162, filed on Sep. 28, 2023.

(51) Int. Cl. H04N 7/14

(52) U.S. Cl. CPC H04N 7/147

(57) ABSTRACT

An apparatus configured to initiate a voice call to a target device, generate, for transmission to a first server, a request for a video call link upon a determination that a trigger event has occurred, process, based on signaling received from the first server, a video call link, generate, for transmission to a base station, a message comprising the video call link to be forwarded to the target device and establish a video session with the target device using the video call link while still maintaining the voice call with the target device.

### PRIORITY/INCORPORATION BY REFERENCE

This application claims priority to U.S. Provisional Application Ser. No. 63/586, 162 filed on Sep. 28, 2023, entitled “Video Group Calling,” the entirety of which is incorporated by reference herein.

### BACKGROUND

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS) and are capable of operating sophisticated applications that utilize these functionalities. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

Currently, many types of calls only work for traditional voice audio calls with no video representation. It may be beneficial to have video representation in connection with certain types of calls, e.g., emergency calls, calls to a help center, etc. In addition, it may be useful to also have group call (conference call) functionality with these calls.

### SUMMARY

Some example embodiments are related to an apparatus having processing circuitry configured to initiate a voice call to a target device, generate, for transmission to a first server, a request for a video call link upon a determination that a trigger event has occurred, process, based on signaling received from the first server, a video call link, generate, for transmission to a base station, a message comprising the video call link to be forwarded to the target device and establish a video session with the target device using the video call link while still maintaining the voice call with the target device.

Other example embodiments are related to an apparatus having processing circuitry configured to process, based on signaling received from a first server upon a determination that a voice call has been initiated by an associated UE to a target device and a trigger event has occurred, a notification comprising a video call link generated by the first server in response to the trigger event, generate, for transmission to the first server, a response to be forwarded to the target device, the response indicating a desire to join a video session associated with the video call link between the associated UE and the target device and establish the video session between the apparatus, the associated UE, and the target device using the video call link.

Still further example embodiments are related to an apparatus having processing circuitry configured to receive a request for a video call link from a first user equipment (UE) upon a determination that a trigger event has occurred, wherein the first UE has initiated a voice call to a target device, generate, for transmission to the first UE, a video call link to be forwarded to the target device, the video call link configured to establish a video session between the first UE and the target device, automatically transmit a notification to a second UE associated with the first UE, the notification comprising the video call link and, upon receiving an indication from the second UE that the second UE wishes to join the video session using the video call link, generating, for transmission to the target device, an alert that the second UE wishes to join the video session between the first UE and the target device, the alert being configured to allow the target device to automatically patch the second UE into the video session.

Additional example embodiments are related to an apparatus having processing circuitry configured to process, based on signals originated from a first user equipment (UE), a request to establish a voice call, establish the voice call with the first UE, process, based on signals forwarded from the first UE, a video call link that is generated in response to an occurrence of a trigger event and establish a video session with the first UE using the video call link while still maintaining the voice call with the first UE.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example server according to various example embodiments.

FIG. 4 shows an example architecture and call flow according to various example embodiments.

### DETAILED DESCRIPTION

The example embodiments may be further understood with reference to the following description and the related appended drawings, wherein like elements are provided with the same reference numerals. The example embodiments relate to creating a group calling solution with video support for telephony calls.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a fifth generation (5G) New Radio (NR) network and a next generation node B (gNB). However, reference to a 5G NR network and a gNB is merely provided for illustrative purposes. The example embodiments may be utilized with any appropriate type of network (e.g., 5G-advanced, 6g, etc.) and base station.

When a UE is trying to make a call, there may be a need for video representation, as some calls currently work only with voice audio. In addition, in some situations, it may be useful to have group call (conference call) functionality, e.g., when one of the participants is a child, an adult with a learning disability, an older adult, etc. Having group call functionality would allow a parent or other adult to be on the call and help interpret and/or assist in communicating. Moreover, the group call functionality with or without video support could apply to other situations, such as a parent wanting to monitor or be involved with a call from their child's communication device to a particular telephone number or using a certain application. In particular, the ability to automatically patch a parent or guardian into a communication involving their child, with or without video support, to allow an automatic three-way call may be beneficial. In addition, there are other personal or business situations where having the ability to automatically patch a third party into a communication, particularly with video support, might be useful. The example embodiments allow for automatic switching from a carrier voice over NR (VoNR) call or a Voice over LTE (VoLTE) call to a VoIP based video session.

The example embodiments describe operations for a user equipment (UE), server, or other communication device, to allow for automatic switching from a carrier voice over NR (VoNR) call or a Voice over LTE (VoLTE) call to a VoIP based video session, the automatic addition of a third party (such as a parent or guardian) to a call, and the implementation of video calling for such calls.

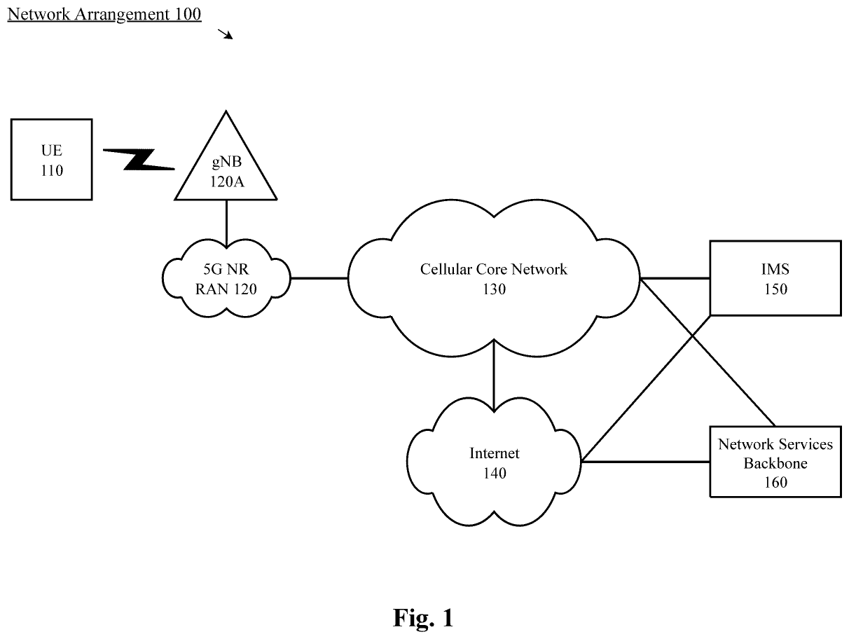

FIG. 1 shows an example network arrangement 100 according to various example embodiments. The example network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

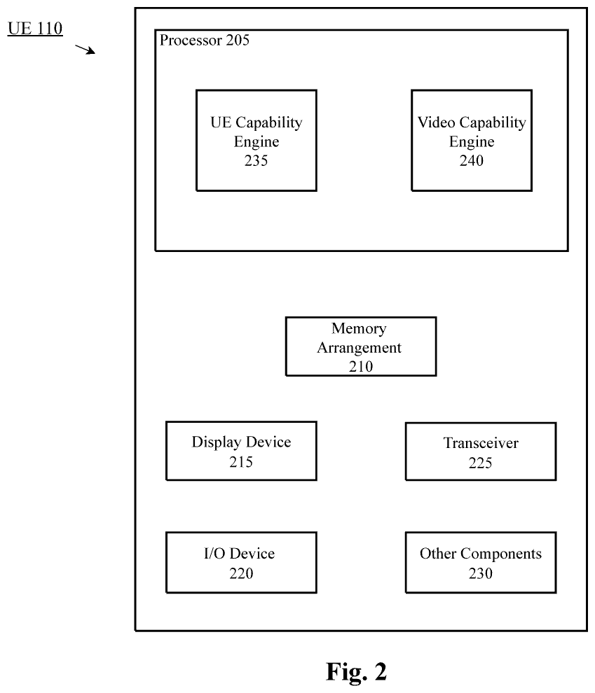

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a UE capability engine 235. The UE capability engine 235 may perform various operations related to the capabilities of the UE 110. To provide some general examples, the UE capability engine 235 may perform operations such as, but not limited to, determining the operating capabilities of the UE 110, determining when the capabilities of the UE 110 should change, informing the network of the capabilities of the UE 110, and the like. In addition, the UE capability engine 235 may perform operations such as initiating, setting up, and conducting voice calls and/or video sessions.

The processor 205 may be configured to execute a plurality of engines of the UE 110. For example, the engines may also include a video capability engine 240. The video capability engine 240 may perform various operations related to initiating, setting up, and carrying out video sessions. To provide some general examples, the video capability engine 240 may perform operations such as, but not limited to, dynamically switching back and forth between voice calls and video sessions and/or conducting and/or maintaining a video session at the same time as a voice call.

The above referenced engines 235 and 240 each being an application (e.g., a program) executed by the processor 205 are merely provided for illustrative purposes. The functionality associated with each of the engines 235 and 240 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

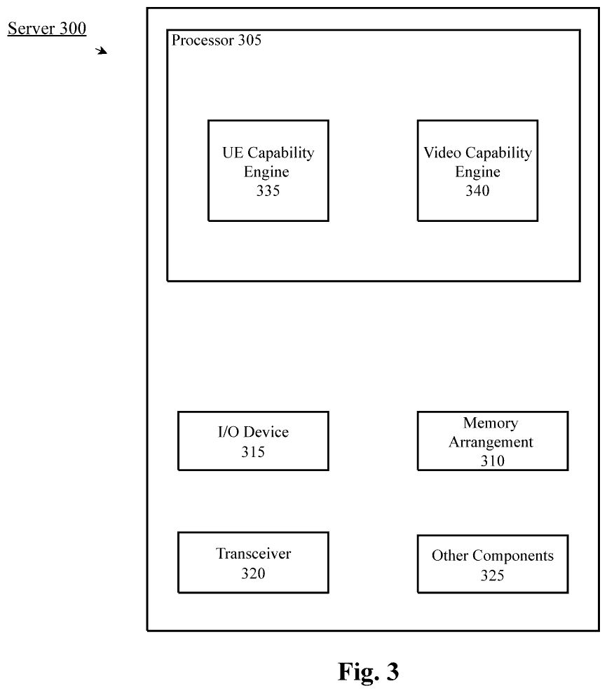

FIG. 3 shows an example server 300 according to various example embodiments. The server 300 may represent multiple servers that are included within the network, e.g., deployed as part of the network services backbone 160 or as separate devices. For example, the server 300 may include a video call server, a voice call server, a VoIP server, a push notification server, etc.

The server 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the server 300 to other electronic devices and/or power sources, TxRUs, transceiver chains, antenna elements, antenna panels, etc.

The processor 305 may be configured to execute a plurality of engines for the server 300. For example, the engines may include a UE capability engine 335. The UE capability engine 335 may perform various operations for the server 300 related to the capabilities of the UE 110. To provide some general examples, the UE capability engine 335 may perform operations such as, but not limited to, transmitting a signal to inquire as to the capabilities of the UE 110, trigger the UE 110 to dynamically switch to a different set of capabilities, transmitting configuration information to the UE 110 to perform operations based on the current capabilities of the UE 110, and the like. In addition, the UE capability engine 335 may perform operations such as initiating, setting up, and conducting voice calls and/or video sessions.

The processor 305 may be configured to execute a plurality of engines for the server 300. For example, the engines may include a video capability engine 340. The video capability engine 340 may perform various operations related to initiating, setting up, and carrying out video sessions. To provide some general examples, the video capability engine 240 may perform operations such as, but not limited to, dynamically switching back and forth between voice calls and video sessions and/or conducting and/or maintaining a video session at the same time as a voice call.

The above noted engines 335 and 340, each being an application (e.g., a program) executed by the processor 305 is only example. The functionality associated with the engines 335 and 340 may also be represented as a separate incorporated component of the server 300 or may be a modular component coupled to the server 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the server 300. The I/O device 315 may be a hardware component or ports that enable a user to interact with the server 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

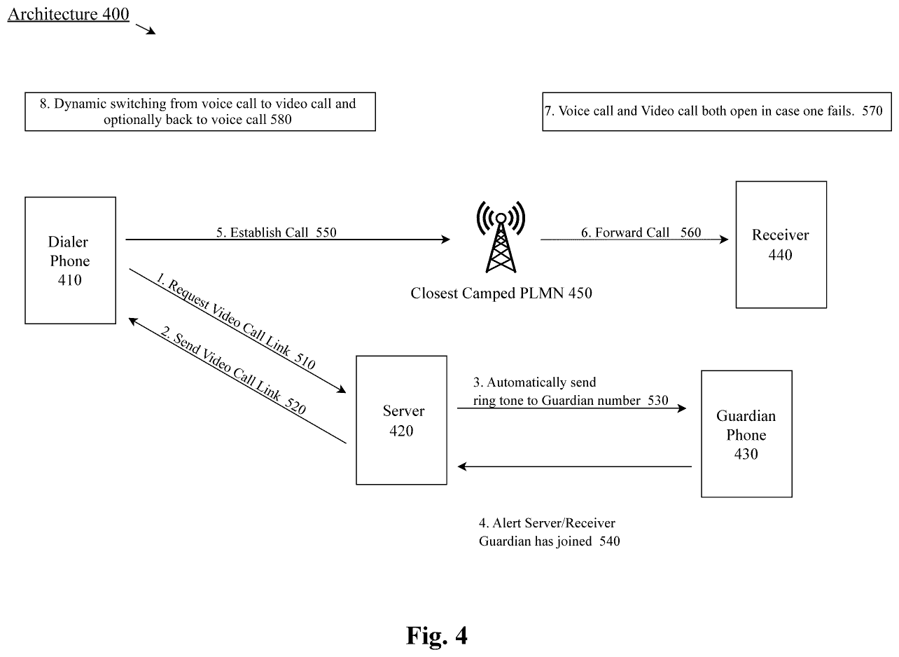

FIG. 4 shows an example architecture 400 and call flow according to various example embodiments. The example architecture 400 may include a first UE 410, which may be a cellular telephone, computer, tablet, or other wireless communication device. The example architecture 400 may also include a first server 420, e.g., the server 300 described above. The example architecture 400 may also include a second UE 430, which may be a cellular telephone, computer, tablet, or other wireless communication device, and in some embodiments, is associated with the first UE 410 as discussed in more detail below. Further, the example architecture 400 may include a target device 440. In some embodiments, the target device 440 may be a second server, such as an emergency call server (e.g., a public safety access point (PSAP)) configured to handle emergency calls. In other embodiments, the target device 440 may be a call center or even an individual or business communications device, and the voice call and associated video session may be a typical, non-emergency voice call and associated video session. In addition, the architecture 400 may include one or more base stations 450, such as a Public Land Mobile Network (PLMN) base station. In one embodiment, the base station 450 may be the closest camped PLMN base station.

In one embodiment, the first UE 410 and the second UE 430 may be associated. For example, the first UE 410 may be a cellular telephone of a child and the second UE 430 may be a cellular telephone of a parent or guardian. There may be a provisioning process where the first UE 410 and the second UE 430 are configured such that when a trigger event associated with the first UE 410 occurs, the second UE 430 is contacted, and in some embodiments, is automatically contacted. In one embodiment, one or more policies are defined in association with one or more of the first UE 110, the second UE 430, and the first server 420, whereby the one or more policies may comprise a number of trigger events, as discussed in more detail below. The provisioning process may include storing identification information, such as names, telephone numbers, and addresses, associated with each of the first UE 410 and the second UE 430, and linking the identification information of the two UEs.

In one example embodiment, a first UE 410 may initiate a call, such a voice call. A second UE 430 may be associated with the first UE 410. For example, the first UE 410 may be associated with a child and the second UE 430 may be associated with a guardian or parent of the child. Further, in some embodiments, the first UE 410 may have access to a telephone number and/or other information associated with the second UE 430.

In some embodiments, the first UE 410 may be configured such that the second UE 430 is contacted using its telephone number or address that is stored in association with the first UE 410 to attempt to set up a group call involving the first UE 410 and the second UE 430 when a trigger event occurs. For example, the first UE 410 may be configured such that the second UE 430 is contacted to attempt to set up a group call involving the first UE 410 and the second UE 430 when a specific type of call is initiated by the first UE 410, e.g., an emergency call, a call to a specific phone number, a call initiated based on a link from a specific website, etc. Other trigger events may include a list of contact telephone numbers or addresses, a time of day when a telephone call is initiated, a combination of time and contact telephone numbers or addresses, the use of a certain application on the first UE 410, a combination of these, or the like. For example, the first UE 410 and the second UE 430 may be configured such that a call initiated by the first UE 410 to a particular telephone number after a certain time of night may be a trigger event for contacting the second UE 430 to attempt to establish a group call, and/or a group call with video support. Another example of a trigger event that can be provisioned on one or both of the first UE 410 and the second UE 430 is when the first UE 410 uses a certain application, such as What's App, Snapchat, or the like, which will trigger a notification being sent to the second UE 430 to allow the second UE 430 to join the communication session initiated by the first UE 410.

In this manner, the second UE 430 may be sent a request to establish a voice call and/or a video link to establish a video session when the trigger event occurs. In some embodiments, emergency signaling may be used as a way to send the video link rapidly. Once the second UE 430 joins the link, there is the ability to switch rapidly while keeping both the voice call and the video session open.

Referring back to FIG. 4, assuming that the first UE 410 and second UE 430 are configured accordingly, when a trigger event occurs, the first UE 410 will request a video call link by sending a request to establish a video call link to a first server 420 (510). In some embodiments, the request for the video call link may occur before the voice call is set up. Upon receiving the request for the video call link, the first server 420 will send a newly generated video call link to the first UE 410 (520). The video call link will include the information to set up a video session between the first UE 410 and one or more of the target device 440 and the second UE 430.

If the trigger event has occurred, the first server 420 will also automatically attempt to connect with the second UE 430, such as by sending a notification, such as a ring tone, to a telephone number associated with the second UE 430 which has been previously saved (530). In some embodiments, the first server 420 may also send an alert to the second UE 430 via text, short message service (SMS), or other messaging that the first UE 410 has initiated a call to a telephone number of interest. For example, if the first UE 410 is associated with a child making a 911 call, and the second UE 430 is associated with a parent or guardian, the first server 420 may also send an alert to the second UE 430 indicating that their child initiated an emergency call. In some embodiments, as part of the notification sent to the second UE 430 (530), the first server 420 may also send the video call link it previously generated (530) to the second UE 430. If the second UE 430 answers the call and/or clicks the video call link, a message may be sent to the first server 420 and/or the first UE 410 that the second UE 430 has joined the call, which may be passed along by the first server 420 to alert the target device 440 and/or the first UE 410 that the second UE 430 has joined the call (540).

Once the first UE 410 receives the newly generated video call link including the information necessary to set up a video session between the first UE 410 and one or more of the target device 440 and the second UE 430 from the first server 420, the first UE 410 will send a message to the base station 450 to establish the call with a target device 440 (550). The call may be a voice over NR (VoNR) call or a Voice over LTE (VoLTE) call. The message sent by the first UE 410 to the base station 450 may include the video call link generated by the first server 420 and may also include associated information. In some embodiments, the video call link and associated information may be sent to the base station 450 in a Session Initiation Protocol (SIP) header. The base station 450 then may forward the call and the video call link with any associated information to the target device 440 (560). The target device 440 may have the functionality to, and be configured to, set up voice calls and to set up video sessions using a video call link, such as via a video call link sent via a SIP header in a typical voice initiation message.

The target device 440 may then open up the video call link to establish a video session in conjunction with the voice call (570). In some example embodiments, if the target device 440 has video capability, as soon as it receives the video call link, the target device 440 will automatically open the video call link to establish the video session and may also automatically switch from the voice call to the video session as the primary session. In some example embodiments, the first UE 410 may automatically switch from the voice call to the video session upon receiving an indication that the target device has received the video call link (580).

By opening up the video session, such as via a second monitor, both a normal voice call and a video session may kept open at the same time, offering redundancy in case one fails. Also, in some embodiments, the target device 440, upon receiving the alert that the second UE 430 has joined the voice call, the target device 440 will automatically switch to a three-way group voice call. In other example embodiments, the target device 440, upon receiving an alert that the second UE 430 has clicked the link to join the video session, the target device 440 will automatically switch to a three-way group video session (580). In still other embodiments, the target device 440, upon receiving an alert that the second UE 430 has clicked the link to join the video session, the target device 440 will automatically switch to a three-way group video session if the pre-established policy definitions indicate such an automatic switch is desired. In this manner, the original two-way voice call may be automatically switched to a three-way group video session.

Notably, after 570 and 580 above, both the voice call and the video call may be open, but the “foreground” application that the users are seeing may be dynamically switched based on the current situation. That is, in some example embodiments, dynamic switching between the voice call and the video call may occur. Initially, the first UE 410 may make a call to the target device 440, and a video call will be opened while the voice call is still open, as disclosed above. Both the voice call and the video call are running at this time. When the second UE 430 receives the link and joins the call, the call that all users are seeing may be switched from the voice call to the video call (580). If the second UE 430 releases the call for any reason, the call that the remaining users see may be switched to either the voice call or a video call with just the first UE 410 and the target device 440, depending on network conditions or user input. Thus, dynamic switching from the voice call to the video call, and vice versa, may be achieved. Both the voice call and the video call may remain open, and the system may quickly switch from one to the other, but only one of them may be seen to the users. This dynamic switching may be automatic and seamless, and the users do not need to distinguish what type of call they currently are on.

In addition, the video session may be preferred in some situations, such as for video and parent communication. One example would be where a child has called 911 and a parent may be able to assist using the video session. In addition, in an emergency situation, the video session could be helpful to emergency personnel in showing them injuries, a crime scene, how to enter a building, and similar things. Once the video session is set up, a three way group call with both audio and video exists between the first UE 410, the second UE 430, and the target device 440 (such as a PSAP). The parties can communicate with each other through both the audio call and the video session, including via a camera in the first UE 410 and/or the second UE 430.

In some example embodiments, there may be a preference for the video session, but the normal voice call (such as a SIP call) is kept open in case there is a failure or degradation in the quality of service (QoS) of the video session. In one embodiment, the video session may be automatically switched to the voice call (or vice versa) in the event the video session is dropped and/or if the quality of the video session falls below a predetermined threshold. The base station 450 and/or the first and second UEs 410 and 430 may perform typical quality of service measurements to determine if there is a failure or degradation in the quality of service of the video session and/or the voice call and whether a switch between the voice call and the video session is desired, and/or if one of the voice call and the video session is to be re-established. For example, if the voice call and/or the video session is dropped, the target device 440 may be able to re-establish a call with the first UE 410 and/or the second UE 430 using the video call link previously sent to the target device 440. In addition, one of the parties (first UE 410, second UE 430, or target device 440) can request to switch from the voice call to the video session, or vice versa.

In addition, in some example embodiments, the voice call and/or the video session may consist of, and/or may include encrypted communication between the target device 440 (the PSAP in some embodiments) and the call parties (the first UE 410 and/or the second UE 430). Also, the voice call and/or the video session may be fully recorded to be studied by persons associated with the target device 440 (e.g., at a call center for training purposes) at a later time.

The call flow in FIG. 4 is only an example, and the actions performed do not necessarily have to be performed in a certain order. For example, the second UE 430 joining the voice call (530) and the alert being sent that the second UE 430 has joined (540) may occur after the voice call has been forwarded to the target device 440 (560) and/or after the target device 440 has opened up the video call link to establish the video session with the first UE 410 (570). This may occur where the second UE 410 does not get the original notification (530) or does not immediately accept the call, but only accepts the call after the voice call has been forwarded to the target device 440 (560) to establish the voice call between the first UE 410 and the target device 440 and/or after the target device 440 has opened up the video call link to establish the video session with the first UE 410 (570).

According to the disclosed embodiments, group video calling (or video calls with group support) is enabled, and in particular, automatic parent/guardian patching for emergency situations involving children with group video calling is disclosed. This functionality may be used in many environments, including supporting and helping children in emergency situations, since they may be unable to respond to PSAP operators in a helpful way. The group video calling discussed herein allows a parent or guardian to help and interpret their problems in these emergency situations. This functionality will provide solutions to protect minors and respect family laws, allowing children and families peace of mind and establishing wireless communication devices as a safety device for children.

### EXAMPLES

In a first example, a method, comprising initiating a voice call to a target device, generating, for transmission to a first server, a request for a video call link upon a determination that a trigger event has occurred, processing, based on signaling received from the first server, a video call link, generating, for transmission to a base station, a message comprising the video call link to be forwarded to the target device and establishing a video session with the target device using the video call link while still maintaining the voice call with the target device.

In a second example, the method of the first example, wherein the voice call is an emergency call and the target device is a public safety access point (PSAP).

In a third example, the method of the first example, further comprising automatically establishing the video session with the target device using the video call link.

In a fourth example, the method of the first example, further comprising automatically switching from the voice call to the video session upon receiving an indication that the target device has received the video call link.

In a fifth example, the method of the first example, further comprising enabling the apparatus to participate in a group video session with the target device and a second UE upon a determination that the second UE has received the video call link from the first server and has indicated to the target device that the second UE wishes to join the video session.

In a sixth example, the method of the first example, further comprising sending an instruction to the target device to switch from the voice call to the video session.

In a seventh example, the method of the first example, wherein the apparatus is provisioned with one or more predefined policies, wherein the one or more predefined policies comprise one or more trigger events.

In an eighth example, the method of the seventh example, wherein the one or more trigger events comprise one or more of the following: an emergency call being initiated; a call being initiated to a telephone number or address on a predefined list of contact telephone numbers or addresses; a call being initiated at a predefined time of day; a call being initiated using a certain predefined application on the UE, or a combination thereof.

In a ninth example, the method of the first example, further comprising switching from the video session to the voice call upon a determination that there is a failure of the video session or a degradation in the quality of service (QoS) of the video session below a predefined threshold.

In a tenth example, the method of the ninth example, wherein, if the video session is dropped due to a failure or a degradation in the QoS of the video session below a predefined threshold, the processing circuitry is configured to re-establish a video session with the target device upon receiving a request from the target device using the video call link.

In an eleventh example, the method of the first example, wherein the video call link is sent to the base station from the UE in a Session Initiation Protocol (SIP) header.

In a twelfth example, the method of the first example, wherein the target device is a call center.

In a thirteenth example, a processor configured to perform any of the methods of the first through twelfth examples.

In a fourteenth example, a user equipment (UE) configured to perform any of the methods of the first through twelfth examples.

In a fifteenth example, a method, comprising processing, based on signaling received from a first server upon a determination that a voice call has been initiated by an associated UE to a target device and a trigger event has occurred, a notification comprising a video call link generated by the first server in response to the trigger event, generating, for transmission to the first server, a response to be forwarded to the target device, the response indicating a desire to join a video session associated with the video call link between the associated UE and the target device and establishing the video session between the apparatus, the associated UE, and the target device using the video call link.

In a sixteenth example, the method of the fifteenth example, wherein the voice call is an emergency call and the target device is a public safety access point (PSAP).

In a seventeenth example, the method of the fifteenth example, further comprising automatically establishing the video session with the target device and the associated UE using the video call link.

In an eighteenth example, the method of the fifteenth example, wherein the response sent to the first server to be forwarded to the target device indicating a desire to join the video session associated with the video call link between the associated UE and the target device is sent after a voice call is established between the associated UE and the target device.

In a nineteenth example, the method of the eighteenth example, further comprising sending an instruction to the target device to switch from the voice call to the video session.

In a twentieth example, the method of the fifteenth example, wherein the apparatus is provisioned with one or more predefined policies, wherein the one or more predefined policies comprise one or more trigger events.

In a twenty first example, the method of the twentieth example, wherein the one or more trigger events comprise one or more of the following: an emergency call being initiated by the associated UE; a call being initiated by the associated UE to a telephone number or address on a predefined list of contact telephone numbers or addresses; a call being initiated by the associated UE at a predefined time of day; a call being initiated by the associated UE using a certain predefined application on the associated UE, or a combination thereof.

In a twenty second example, the method of the fifteenth example, wherein, if the video session is dropped due to a failure or a degradation in the QoS of the video session below a predefined threshold, the processing circuitry is configured to re-establish a video session with the target device and the associated UE upon receiving a request from the target device using the video call link.

In a twenty third example, a processor configured to perform any of the methods of the fifteenth through twenty second examples.

In a twenty fourth example, a user equipment (UE) configured to perform any of the methods of the fifteenth through twenty second examples.

In a twenty fifth example, a method, comprising receiving a request for a video call link from a first user equipment (UE) upon a determination that a trigger event has occurred, wherein the first UE has initiated a voice call to a target device, generating, for transmission to the first UE, a video call link to be forwarded to the target device, the video call link configured to establish a video session between the first UE and the target device, automatically transmitting a notification to a second UE associated with the first UE, the notification comprising the video call link and, upon receiving an indication from the second UE that the second UE wishes to join the video session using the video call link, generating, for transmission to the target device, an alert that the second UE wishes to join the video session between the first UE and the target device, the alert being configured to allow the target device to automatically patch the second UE into the video session.

In a twenty sixth example, the method of the twenty fifth example, further comprising generating, for transmission to the first UE, an alert that the second UE wishes to join the video session between the first UE and the target device upon receiving an indication from the second UE that the second UE wishes to join the video session using the video call link.

In a twenty seventh example, the method of the twenty fifth example, wherein the voice call is an emergency call and the target device is a public safety access point (PSAP).

In a twenty eighth example, the method of the twenty fifth example, wherein the apparatus is provisioned with one or more predefined policies for the first and second UEs, wherein the one or more predefined policies comprise one or more trigger events.

In a twenty ninth example, the method of the twenty fifth example, wherein the one or more trigger events comprise one or more of the following: an emergency call being initiated by the first UE; a call being initiated by the first UE to a telephone number or address on a predefined list of contact telephone numbers or addresses; a call being initiated by the first UE at a predefined time of day; a call being initiated by the first UE using a certain predefined application on the first UE, or a combination thereof.

In a thirtieth example, a processor configured to perform any of the methods of the twenty fifth through twenty ninth examples.

In a thirty first example, a server configured to perform any of the methods of the twenty fifth through twenty ninth examples.

In a thirty second example, a method, comprising processing, based on signals originated from a first user equipment (UE), a request to establish a voice call, establishing the voice call with the first UE, processing, based on signals forwarded from the first UE, a video call link that is generated in response to an occurrence of a trigger event and establishing a video session with the first UE using the video call link while still maintaining the voice call with the first UE.

In a thirty third example, the method of the thirty second example, wherein the voice call is an emergency call and the target device is a public safety access point (PSAP).

In a thirty fourth example, the method of the thirty second example, further comprising automatically establishing the video session with the first UE using the video call link.

In a thirty fifth example, the method of the thirty second example, further comprising automatically switching from the voice call to the video session upon receiving the video call link.

In a thirty sixth example, the method of the thirty second example, further comprising processing an indication that a second UE wishes to join the video session and automatically patch the second UE into the video session upon receiving the indication.

In a thirty seventh example, the method of the thirty second example, further comprising switching from the voice call to the video session based on an instruction received from one of the first UE and the second UE.

In a thirty eighth example, the method of the thirty second example, further comprising switching from the video session to the voice call upon a determination that there is a failure of the video session or a degradation in the quality of service (QoS) of the video session below a predefined threshold.

In a thirty ninth example, the method of the thirty eighth example, wherein, if the video session is dropped due to a failure or a degradation in the QoS of the video session below a predefined threshold, the method further comprising re-establishing a video session with the first UE and the second UE using the video call link.

In a fortieth example, the method of the thirty second example, further comprising processing the video call link forwarded from the UE in a Session Initiation Protocol (SIP) header.

In a forty first example, the method of the thirty second example, wherein the method is performed by a call center.

In a forty second example, a processor configured to perform any of the methods of the thirty second through forty first examples.

In a forty third example, a user equipment (UE) configured to perform any of the methods of the thirty second through forty first examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICS. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
initiate a voice call to a target device;
generate, for transmission to a first server, a request for a video call link upon a determination that a trigger event has occurred;
process, based on signaling received from the first server, a video call link;
generate, for transmission to a base station, a message comprising the video call link to be forwarded to the target device; and
establish a video session with the target device using the video call link while still maintaining the voice call with the target device.

2. The apparatus of claim 1, wherein the voice call is an emergency call and the target device is a public safety access point (PSAP).

3. The apparatus of claim 1, wherein the processing circuitry is configured to automatically establish the video session with the target device using the video call link.

4. The apparatus of claim 1, wherein the processing circuitry is configured to automatically switch from the voice call to the video session upon receiving an indication that the target device has received the video call link.

5. The apparatus of claim 1, wherein the processing circuitry is configured to enable the apparatus to participate in a group video session with the target device and a second UE upon a determination that the second UE has received the video call link from the first server and has indicated to the target device that the second UE wishes to join the video session.

6. The apparatus of claim 1, wherein the processing circuitry is configured to send an instruction to the target device to switch from the voice call to the video session.

7. The apparatus of claim 1, wherein the apparatus is provisioned with one or more predefined policies, wherein the one or more predefined policies comprise one or more trigger events.

8. The apparatus of claim 7, wherein the one or more trigger events comprise one or more of the following: an emergency call being initiated; a call being initiated to a telephone number or address on a predefined list of contact telephone numbers or addresses; a call being initiated at a predefined time of day; a call being initiated using a certain predefined application on the UE, or a combination thereof.

9. The apparatus of claim 1, wherein the processing circuitry is configured to switch from the video session to the voice call upon a determination that there is a failure of the video session or a degradation in the quality of service (QoS) of the video session below a predefined threshold.

10. An apparatus comprising processing circuitry configured to:
process, based on signaling received from a first server upon a determination that a voice call has been initiated by an associated UE to a target device and a trigger event has occurred, a notification comprising a video call link generated by the first server in response to the trigger event;
generate, for transmission to the first server, a response to be forwarded to the target device, the response indicating a desire to join a video session associated with the video call link between the associated UE and the target device; and
establish the video session between the apparatus, the associated UE, and the target device using the video call link.

11. The apparatus of claim 10, wherein the voice call is an emergency call and the target device is a public safety access point (PSAP).

12. The apparatus of claim 10, wherein the processing circuitry is configured to automatically establish the video session with the target device and the associated UE using the video call link.

13. The apparatus of claim 10, wherein the response sent to the first server to be forwarded to the target device indicating a desire to join the video session associated with the video call link between the associated UE and the target device is sent after a voice call is established between the associated UE and the target device.

14. The apparatus of claim 13, wherein the processing circuitry is configured to send an instruction to the target device to switch from the voice call to the video session.

15. The apparatus of claim 10, wherein the apparatus is provisioned with one or more predefined policies, wherein the one or more predefined policies comprise one or more trigger events.

16. The apparatus of claim 15, wherein the one or more trigger events comprise one or more of the following: an emergency call being initiated by the associated UE; a call being initiated by the associated UE to a telephone number or address on a predefined list of contact telephone numbers or addresses; a call being initiated by the associated UE at a predefined time of day; a call being initiated by the associated UE using a certain predefined application on the associated UE, or a combination thereof.

17. An apparatus comprising processing circuitry configured to:
receive a request for a video call link from a first user equipment (UE) upon a determination that a trigger event has occurred, wherein the first UE has initiated a voice call to a target device;
generate, for transmission to the first UE, a video call link to be forwarded to the target device, the video call link configured to establish a video session between the first UE and the target device;
automatically transmit a notification to a second UE associated with the first UE, the notification comprising the video call link; and
upon receiving an indication from the second UE that the second UE wishes to join the video session using the video call link, generating, for transmission to the target device, an alert that the second UE wishes to join the video session between the first UE and the target device, the alert being configured to allow the target device to automatically patch the second UE into the video session.

18. The apparatus of claim 17, wherein the processing circuitry is configured to generate, for transmission to the first UE, an alert that the second UE wishes to join the video session between the first UE and the target device upon receiving an indication from the second UE that the second UE wishes to join the video session using the video call link.

19. The apparatus of claim 17, wherein the voice call is an emergency call and the target device is a public safety access point (PSAP).

20. The apparatus of claim 17, wherein the apparatus is provisioned with one or more predefined policies for the first and second UEs, wherein the one or more predefined policies comprise one or more trigger events.
